(19) United States
(12) Patent Application Publication
(10) Pub. No.: US 2007/0046893 A1
(43) Pub. Date: Mar. 1, 2007

(54) Eyeglass tethers

(76) Inventors: Patricia Ivey Freeman, Stamford, CT (US); Martin James Fettig, Stamford, CT (US)

Correspondence Address: SULLIVAN & WORCESTER LLP, ONE POST OFFICE SQUARE, BOSTON, MA, 02109, US

(21) Appl. No.: 11/211,990

(22) Filed: Aug. 25, 2005

(51) Int. Cl. G02C 3/00

(52) U.S. Cl. 351/157

(57) ABSTRACT

The invention provides eyeglasses with interchangeable and joinable ear engaging members in place of traditional temple arms and tethers.

### FIELD OF THE INVENTION

The invention relates to eyeglasses and eyeglass tethers.

### BACKGROUND OF THE INVENTION

Traditional eyeglasses have two lenses, a nose bridge, and two temple arms, and may also have a frame that surrounds all or a portion of the lenses. Eyeglass tethers may be joined to the distal ends of the temple arms, if desired, so that the eyeglasses can be worn around the neck when the glasses are not in use, or for safety purposes. However, typical eyeglass tethers may not be suitable for other styles of glasses that do not have temple arms, for example, those shown in U.S. Pat. Nos. 5,557,345; D396,052; and D377,037, which describe weighted tethers that extend over the ears, rather than temple arms.

A need therefore exists for eyeglasses that combine the style and versatility of weighted tethers and the ability to wear the eyeglasses around the neck, if desired.

### SUMMARY OF THE INVENTION

In one aspect, the invention provides eyeglasses having two lenses joined by a nose bridge at their inner rims, and ear engaging members. The proximal ends of the ear engaging members are joined to the outer rims of the lenses and are of a sufficient length and weight so as to engage each ear and dangle below it, thereby to secure the glasses on the nose of the wearer. The distal ends of the ear engaging members each have a detachable joining member that joins the distal ends of the ear engaging members. When the two detachable joining members are joined, it provides a tether for the eyeglasses such that they may be worn around the neck when not in use. In an embodiment, the detachable joining member comprises a magnet. In another embodiment, the detachable joining member comprises Velcro, a snap, a button, a hook, a zipper, a plurality thereof, or a combination thereof, for example.

In an embodiment, the eyeglasses of the invention do not have a frame, such that the ear engaging members are attached directly or indirectly to the lenses. In another embodiment, the eyeglasses have a frame that is attached to at least a portion of the inner or outer rim of the first and/or second lens. The ear engaging members may be adapted for use for a multiplicity of framed and frameless eyeglass styles, including corrective eyeglasses, protective eyeglasses (e.g., sunglasses or goggles), and reading glasses.

In an embodiment, the ear engaging member is detachable from the lens or the frame. The lenses and/or frame may be any suitable size or any desired shape, such as, for example, substantially oval, rectangular, square, or round.

In an embodiment, the ear engaging members provide a counterweight to the eyeglasses to stabilize the eyeglasses when engaged with the ears.

### BRIEF DESCRIPTION OF THE DRAWINGS

The foregoing and other objects, features and advantages of the present invention, as well as the invention itself, will be more fully understood from the following description of preferred embodiments when read together with the accompanying drawings, in which:

FIG. 1A provides an illustration of a frameless embodiment of the invention in which the ear engaging members are not joined.

FIG. 1B provides an illustration of a frameless embodiment of the invention in which the ear engaging members are joined.

FIG. 2A provides an illustration of an embodiment of the invention comprising a frame in which the ear engaging members are not joined.

FIG. 2B provides an illustration of an embodiment of the invention comprising a frame in which the ear engaging members are joined.

FIG. 3A provides an illustration of an embodiment of the invention in which the ear engaging members comprise a clasp and eye.

FIG. 3B provides an illustration of an embodiment of the invention in which the ear engaging members comprise a hook and eye.

FIG. 3C provides an illustration of an embodiment of the invention in which the ear engaging members comprise a button and button hole.

FIG. 3D provides an illustration of an embodiment of the invention in which the ear engaging members comprise a male and female snap.

### DETAILED DESCRIPTION OF THE INVENTION

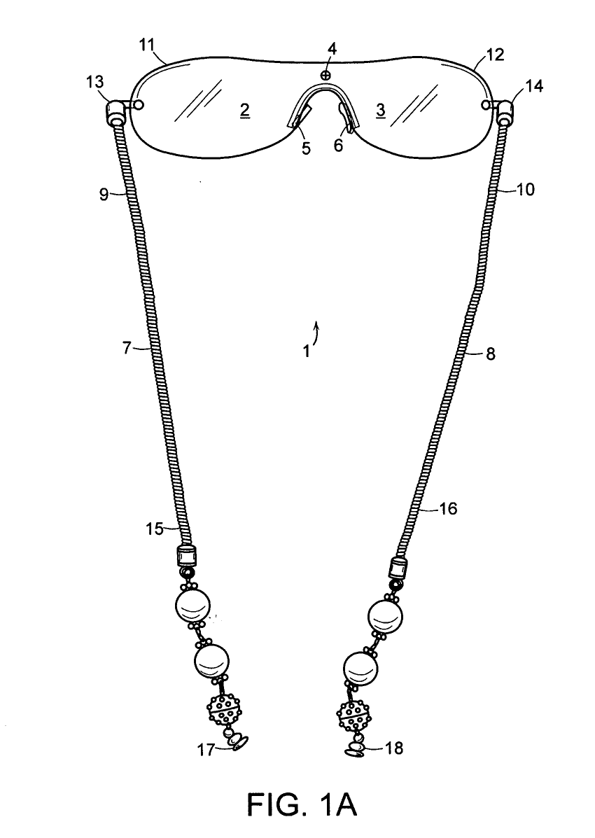

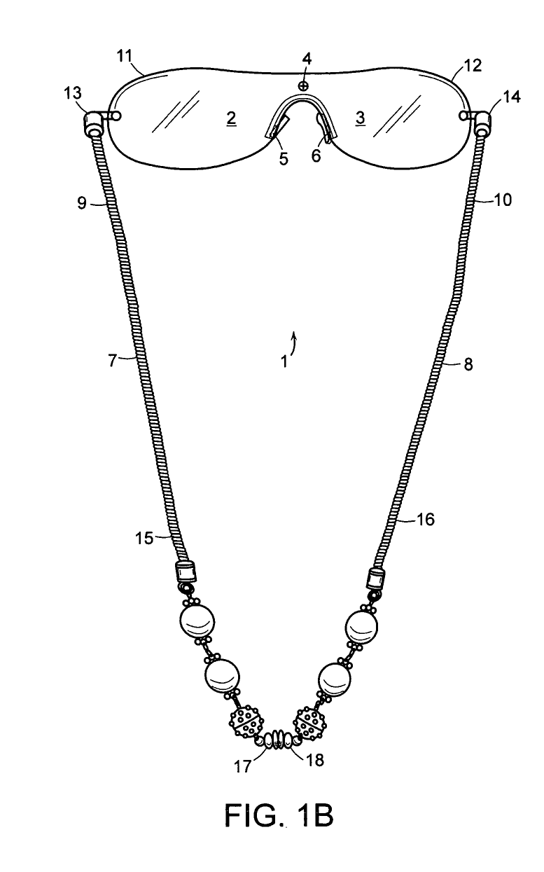

Referring to an embodiment of the invention shown in FIG. 1A, the invention provides eyeglasses 1 having two lenses 2,3 joined by a nose bridge 4 at their inner rims 5,6 and ear engaging members 7, 8. The proximal ends 9,10 of the ear engaging members 7,8 are joined to the outer rims 11,12 of the lenses at connecting members 13,14 and are of a sufficient length and weight so as to engage each ear and dangle below it, thereby to secure the eyeglasses 1 on the nose of the wearer. The distal ends 15,16 of the ear engaging members 7,8 have a detachable joining member 17,18 that joins the distal ends 15,16 of the ear engaging members 7,8 when desired. Referring now to FIG. 1B, when the two detachable joining members 17,18 are joined, it provides a tether for the eyeglasses 1 such that they may be worn around the neck when not in use.

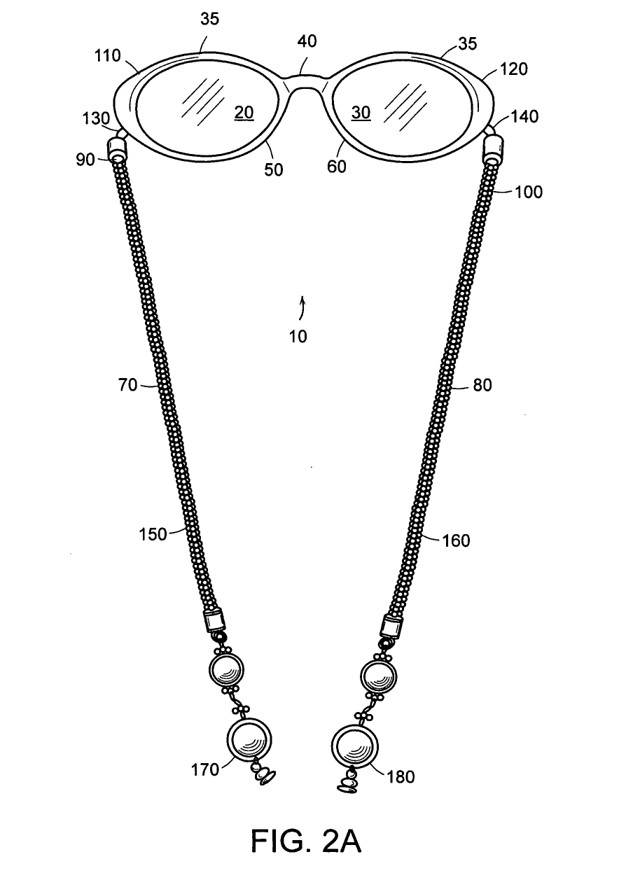

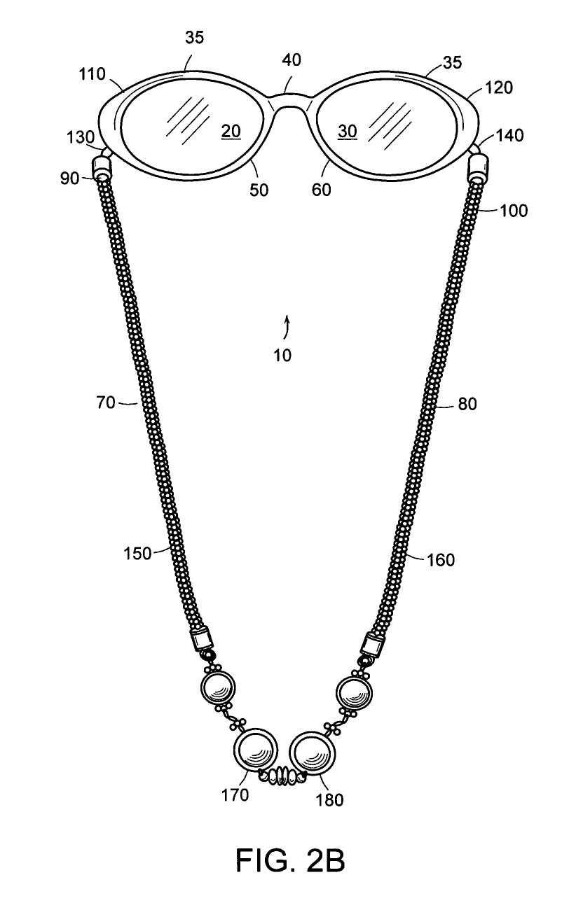

Referring to an embodiment of the invention shown in FIG. 2A, the invention provides eyeglasses 10 having two lenses 20,30, a frame 35 comprising a nose bridge 40, and ear engaging members 70, 80. The proximal ends 90,100 of the ear engaging members 70,80 are joined to the outer rims 110,120 of the frame at connecting members 130,140 and are of a sufficient length and weight so as to engage each ear and dangle below it, thereby to secure the eyeglasses 10 on the nose of the wearer. The distal ends 150,160 of the ear engaging members 70,80 have a detachable joining member 170,180 that joins the distal ends 150,160 of the ear engaging members 70,80 when desired. Referring now to FIG. 2B, when the two detachable joining members 170,180 are joined, it provides a tether for the eyeglasses 10 such that they may be worn around the neck when not in use.

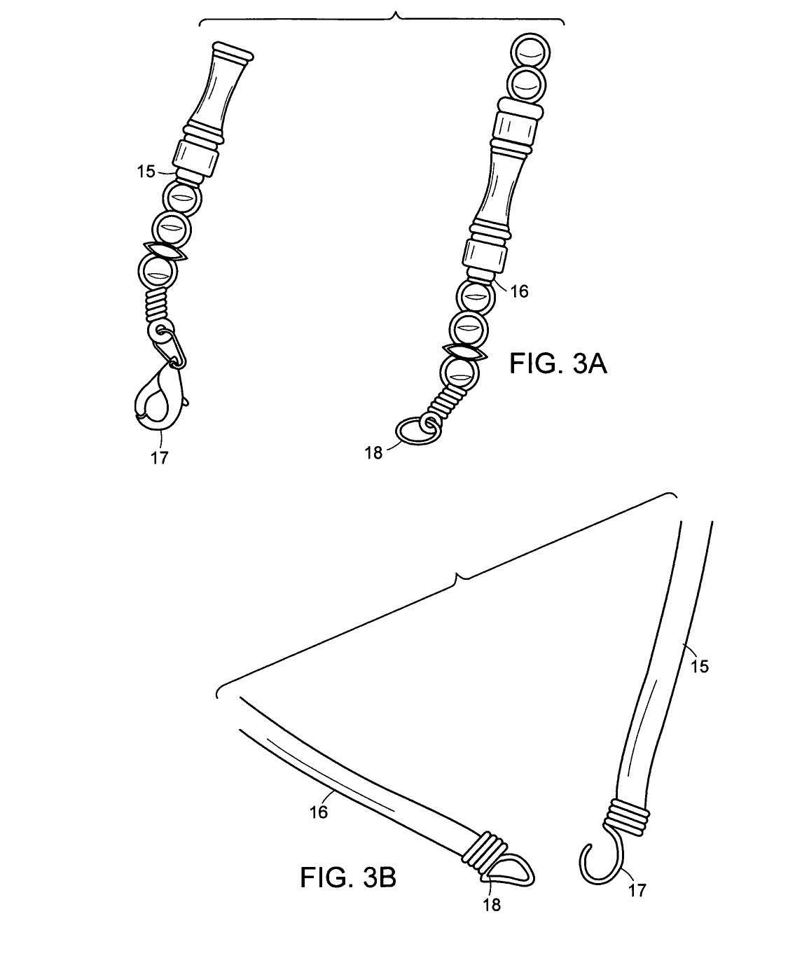

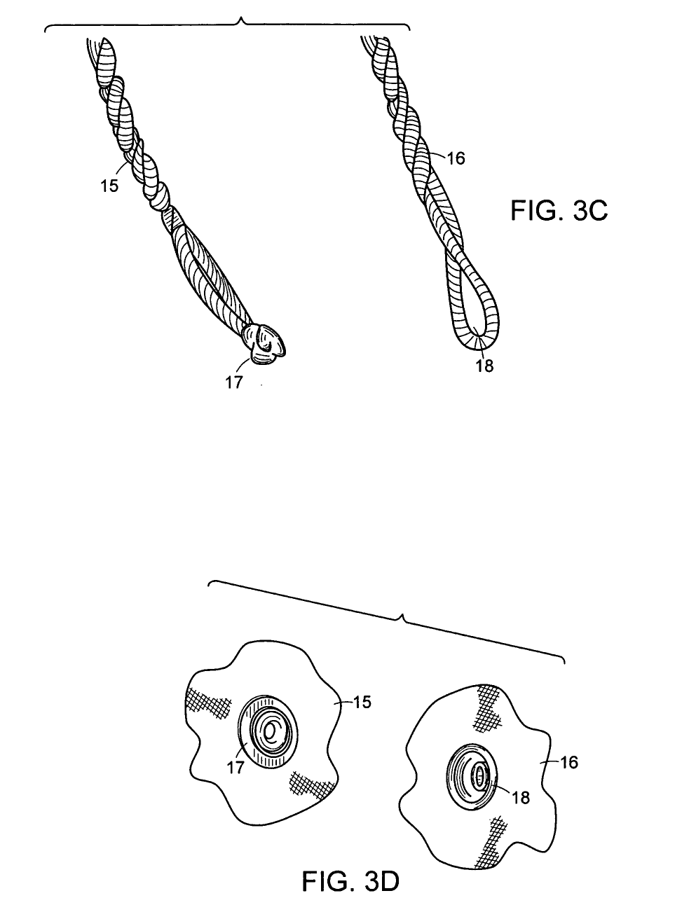

Referring again to FIGS. 1A and 1B, in an embodiment, the detachable joining members 17,18 comprise a magnet. Referring now to FIGS. 3A-3D, in other embodiments, the detachable joining members 17,18 comprise Velcro, a clasp, a snap, a button, a hook, a zipper, a plurality thereof, or a combination thereof.

The ear engaging members 7,8,70,80 may be made of any material of a suitable weight, such as metal, glass, plastic, fabric, leather, cord, and/or ceramic. In an embodiment, the ear engaging members 7,8,70,80 are made of joined beads. In another embodiment, the ear engaging members 7,8,70,80 are made of chain. In an embodiment, the weight of the ear engaging members 7,8,70,80 may be from about 2 ounces to about 7 ounces, preferably about 5 ounces. The length of the ear engaging members 7,8,70,80 may be from about 8 inches to about 10 inches in length, preferably about 9 inches in length for example. In an embodiment, the ear engaging members 7,8,70,80 are of a sufficient length such that they can be joined while the glasses are being worn.

In an embodiment, the ear engaging members 7,8,70,80 are detachable from the lens 2,3 or the frame 35. Any suitable connecting member 13,14,130,140 can be used to connect the ear engaging members 7,8,70,80 to the lenses 2,3,20,30 or frame 35. For example, the connecting members 13, 14, 130, 140 may comprise Velcro, a magnet, a clasp, a snap, a button, a hook, a zipper, a plurality thereof, or a combination thereof, for example.

### INCORPORATION BY REFERENCE

The contents of all cited references (including literature references, patents, patent applications, and websites) that maybe cited throughout this application are hereby expressly incorporated by reference. The practice of the present invention will employ, unless otherwise indicated, conventional techniques of eyeglass and jewelry manufacture, which are well known in the art.

### EQUIVALENTS

The invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims rather than by the foregoing description, and all changes that come within the meaning and range of equivalency of the claims are therefore intended to be embraced herein.

We claim:

1. Eyeglasses comprising,
(a) a first lens and a second lens, each lens comprising an inner rim and an outer rim;
(b) a nose bridge joining the inner rims of the first lens and the second lens; and
(c) a first ear engaging member and a second ear engaging member, each ear engaging member comprising a proximal end and a distal end; wherein the proximal end of the first ear engaging member is joined to the outer rim of the first lens and the proximal end of the second ear engaging member is joined to the outer rim of the second lens, wherein the distal end of the first ear engaging member and the second ear engaging member comprises a detachable joining member that joins the distal ends of the first and second ear engaging members.

2. Eyeglasses comprising,
(a) a first lens and a second lens, each lens comprising an inner rim and an outer rim;
(b) a frame comprising a nosepiece, a first lateral portion, and a second lateral portion, wherein the frame is attached to at least a portion of at least one of an inner rim and an outer rim of at least one of the first lens and the second lens; and
(c) a first ear engaging member and a second ear engaging member, each ear engaging member comprising a proximal end and a distal end, and wherein the proximal end of the first ear engaging member is joined to the first lateral portion of the frame and the proximal end of the second ear engaging member is joined to the second lateral portion of the frame; wherein the distal end of the first ear engaging member and the second ear engaging member comprises a detachable joining member that joins the distal ends of the first and second ear engaging members.

3. The eyeglasses of claim 1, wherein the ear engaging member is detachable from the lens.

4. The eyeglasses of claim 2, wherein the ear engaging member is detachable from the frame.

5. The eyeglasses of claim 1 or 2, wherein the ear engaging member provides a counterweight to the eyeglasses, thereby to stabilize the eyeglasses when engaged with an ear.

6. The eyeglasses of claim 1 or 2, wherein the ear engaging member comprises at least one material selected from the group consisting of metal, glass, plastic, fabric leather, cord, and ceramic.

7. The eyeglasses of claim 1 or 2, wherein the ear engaging member comprises beads.

8. The eyeglasses of claim 1 or 2, wherein the detachable joining member comprises a magnet.

9. The eyeglasses of claim 1 or 2, wherein the detachable joining member is selected from the group consisting of Velcro, a zipper, a snap, a button, a hook, a plurality thereof, and a combination thereof.

10. The eyeglasses of claim 1 or 2, wherein the frame and lenses are substantially oval.

11. The eyeglasses of claim 1 or 2, wherein the frame and lenses are substantially rectangular.

12. The eyeglasses of claim 1 or 2, wherein the frame and lenses are substantially square.

13. The eyeglasses of claim 1 or 2, wherein the frame and lenses are substantially round.
